(19) United States
(12) Patent Application Publication
(10) Pub. No.: US 2025/0208498 A1
(43) Pub. Date: Jun. 26, 2025

(54) FULL-SHOT LAYOUT CORRECTION METHOD AND MASK MANUFACTURING METHOD INCLUDING THE FULL-SHOT LAYOUT CORRECTION METHOD

(71) Applicant: Samsung Electronics Co., Ltd., Suwon-si (KR)

(72) Inventors: Donggon WOO, Suwon-si (KR); Hungbae AHN, Suwon-si (KR); Heejun LEE, Suwon-si (KR); Gyuyeol CHAI, Suwon-si (KR)

(73) Assignee: Samsung Electronics Co., Ltd., Suwon-si (KR)

(21) Appl. No.: 18/897,457

(22) Filed: Sep. 26, 2024

(30) Foreign Application Priority Data
Dec. 21, 2023 (KR) 10-2023-0188511

(51) Int. Cl. G03F 1/36; G06F 30/27; G06F 119/18

(52) U.S. Cl. CPC G03F 1/36; G06F 30/27; G06F 2119/18

(57) ABSTRACT

A full-shot layout correction method includes inputting data of a full-shot layout, extracting a density map from the full-shot layout, extracting a blurred density map by blurring the density map, defining a correction area based on the blurred density map, separating a cell pattern and a core pattern, which overlap the correction area, performing an optical proximity correction (OPC) on the cell pattern, and reconstructing a full-shot layout by using the cell pattern on which the OPC has been performed.

### CROSS-REFERENCE TO RELATED APPLICATION

This application is based on and claims priority under 35 U.S.C. § 119 to Korean Patent Application No. 10-2023-0188511, filed on Dec. 21, 2023, in the Korean Intellectual Property Office, the disclosure of which is incorporated by reference herein in its entirety.

### BACKGROUND

The inventive concepts relate to a full-shot layout correction method and a mask manufacturing method including the full-shot layout correction method.

Among the manufacturing processes of a semiconductor device, a lithography process is a core process technology for forming circuit patterns by irradiating light rays to a photosensitive film applied on a substrate. As patterns are miniaturized, an optical proximity effect (OPE) due to the effects between neighboring patterns occurs during an exposure process. To overcome this problem, an optical proximity correction (OPC) method, which is a method of suppressing the occurrence of the OPE by correcting a pattern layout on a mask that transfers the pattern, is commonly used in a mask manufacturing process.

### SUMMARY

The inventive concepts provide a full-shot layout correction method that saves time and cost.

The inventive concepts provide a full-shot layout correction method with improved performance and reliability.

The inventive concepts provide a mask manufacturing method that saves time and cost.

The inventive concepts provide a mask manufacturing method with improved performance and reliability.

The inventive concepts provide a full-shot layout correction method. According to an aspect of the inventive concepts, there is provided a full-shot layout correction method including extracting a density map from a full-shot layout; extracting a blurred density map by blurring the density map; defining a correction area based on the blurred density map; separating a cell pattern and a core pattern, which overlap the correction area, from the blurred density map; performing an optical proximity correction (OPC) on the cell pattern; and reconstructing the full-shot layout using the cell pattern on which the OPC has been performed.

According to another aspect of the inventive concepts, there is provided a full-shot layout correction method. The full-shot correction method includes extracting a density map from a full-shot layout; extracting a blurred density map by blurring the density map; defining a correction area based on the blurred density map; separating a cell pattern and a core pattern, which overlap the correction area, from the blurred density map; performing an optical proximity correction (OPC) on the cell pattern; and performing an OPC on the core pattern based on the cell pattern on which the OPC has been performed.

According to another aspect of the inventive concepts, there is provided a mask manufacturing method. The mask manufacturing method includes extracting a density map from a full-shot layout, the full-shot layout comprising a cell pattern and a core pattern; extracting a blurred density map by blurring the density map; defining, based on the blurred density map, an area in the full-shot layout as a correction area, the correction area having at least one of a density of the cell pattern or a density of the core pattern greater than a preset value; separating the cell pattern and the core pattern, which overlap the correction area, from the blurred density map; grouping data of the cell pattern into a plurality of cell pattern groups; hierarchically pluralizing the plurality of cell pattern groups; performing an optical proximity correction (OPC) on the cell pattern of the plurality of cell pattern groups on which the hierarchically pluralizing has been performed; reconstructing the full-shot layout using the cell pattern on which the OPC has been performed; grouping the data of the core pattern into a plurality of core pattern groups; hierarchically pluralizing the plurality of core pattern groups; performing an OPC on the core pattern of the plurality of core pattern groups on which the hierarchically pluralizing has been performed, based on the cell pattern on which the OPC has been performed; delivering full-shot layout data, on which the OPC has been performed, as mask tape-out (MTO) design data; preparing mask data based on the MTO design data; and preparing a mask by exposing a mask substrate based on the mask data.

### BRIEF DESCRIPTION OF THE DRAWINGS

Embodiments of the inventive concepts will be more clearly understood from the following detailed description taken in conjunction with the accompanying drawings in which:

FIG. 1 is a flowchart illustrating processes of a full-shot layout correction method according to some embodiments;

FIG. 2 is an image showing a density map for a full-chip;

FIG. 3 is an image showing ADI CD measuring results;

FIG. 4 is an image showing a blurred density map for a full-chip;

FIGS. 5A and 5B are images showing a full-shot blurred density map and a correction area, respectively;

FIG. 6 is a flowchart illustrating a process of performing optical proximity correction (OPC) on a cell pattern in a full-shot layout correction method according to some embodiments;

FIGS. 7A to 7C are diagrams schematically illustrating data of cell patterns to explain the process of performing OPC on a cell pattern;

FIGS. 8A to 8C are diagrams schematically illustrating data of cell patterns to explain the process of performing OPC on a cell pattern;

FIGS. 9A and 9B are diagrams schematically illustrating data of cell patterns to explain the process of performing OPC on a cell pattern;

FIG. 10 is a flowchart illustrating a process of performing OPC on a core pattern in a full-shot layout correction method according to some embodiments;

FIG. 11 is an image schematically showing grouping of data of core patterns to describe the process of performing an OPC on the core patterns; and

FIG. 12 is a flowchart schematically illustrating processes of a mask manufacturing method including a full-shot layout correction method according to some embodiments.

### DETAILED DESCRIPTION OF THE EMBODIMENTS

The inventive concepts will now be described more fully with reference to the accompanying drawings, in which embodiments of the inventive concepts are shown. Like reference numerals in the drawings denote like elements, and thus their description will be omitted.

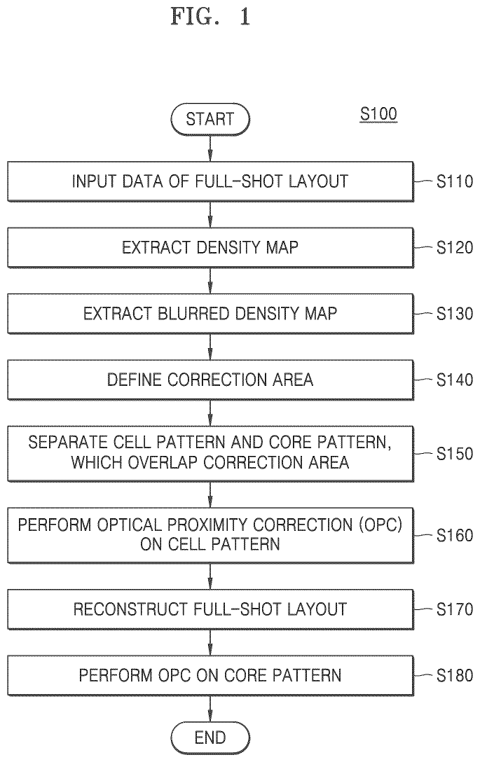

FIG. 1 is a flowchart illustrating processes of a full-shot layout correction method S100 according to some embodiments.

Referring to FIG. 1, data of a full-shot layout may be input into an optical proximity correction (OPC) model (S110). Here, full-shot may refer to a layout of patterns of an entire mask which are transferred to a wafer by one shot in an exposure process for manufacturing a semiconductor device. For example, the data of a full-shot layout may refer to data of a layout of patterns, and the patterns may include a cell pattern and a core pattern.

To describe an exposure process in more detail, patterning a substrate, such as a wafer, may be formed by transferring a pattern on a mask to the substrate through the exposure process. Accordingly, a layout of the pattern on the mask (which corresponds to the pattern to be transferred onto the substrate, that is, a mask layout), may be first designed. For reference, due to the characteristics of an exposure process, the shape of the pattern on the substrate may be generally different from the shape of the pattern on the mask. In addition, because the pattern on the mask is transferred to the substrate by being scaled down and projected to the substrate, the pattern on the mask may have a greater size than the pattern on the substrate. Furthermore, one mask corresponding to a full-shot may correspond to a plurality of chips on a wafer. However, according to at least one embodiment, one mask may also correspond to one chip on a wafer.

As patterns are miniaturized, an optical proximity effect (OPE) due to the effects between neighboring patterns occurs during the exposure process. To overcome this problem, optical proximity correction (OPC) may be performed to suppress the occurrence of OPE by correcting a mask layout. OPC may include the processes of generating an optical image for a corresponding pattern, generating an OPC model, and obtaining an image or data for a mask layout through simulation using the OPC model.

OPC is largely divided into two types, one is rule-based OPC, and the other one is simulation-based or model-based OPC. Because the model-based OPC uses only measurement results of representative patterns without the need to measure all of a large number of test patterns, which may be advantageous in terms of time and cost. OPC may include a method of adding sub-lithographic features, which are called serifs, on a corner of a pattern or a method of adding sub-resolution assist features (SRAFs), such as scattering bars, in addition to changing a mask layout.

In OPC, basic data for OPC is firstly prepared. Here, the basic data may include data about the shapes of patterns of a sample, the positions of the patterns, the types of measurements, such as measurement of a space or line of a pattern, basic measurement values, or the like. In addition, the basic data may include information about a photoresist (PR), such as the thickness, the refractive index, the dielectric constant, and/or the like, and may include a source map about the shape of an illumination system. The basic data is not limited to the data described above.

After the basic data is prepared, an optical OPC model is generated. The generation of the optical OPC model may include optimization of the defocus stand (DS) position, the best focus (BF) position, or the like in an exposure process. In addition, the generation of the optical OPC model may include generating an optical image considering a diffraction phenomenon of light or an optical state of exposure equipment. The generation of the optical OPC model is not limited to the above description. For example, the generation of the optical OPC model may include various contents related to optical phenomena in an exposure process.

After the optical OPC model is generated, an OPC model for a PR is generated. The generation of the OPC model for the PR may include optimization of a threshold value of the PR. Here, the threshold value of the PR may mean a threshold value at which a chemical change occurs in an exposure process, and for example, the threshold value may be given as the intensity of exposure light. The generation of the OPC model of the PR may also include selecting an appropriate model form from several PR model forms.

The optical OPC model and the OPC model for a PR are combined and generally referred to as an OPC model. After the OPC model is generated, a simulation is repeated by using the OPC model. The simulation may be performed so that a certain condition is satisfied. For example, the root mean square (RMS) for a critical dimension (CD) error, EPE, the reference repetition number of times, and/or the like may be used as repetition conditions for a simulation. In the mask layout correction method according to at least one embodiment, layout images or data on which an OPC is performed may be obtained through performing simulations by using the OPC model. The layout images on which the OPC is performed may be delivered to a mask manufacturing team as mask tape-out (MTO) design data for later mask manufacturing.

Thereafter, a density map may be extracted from a full-shot layout (S120). In particular, the extracting of the density map at operation S120 may be performed on a full-shot scale layout, e.g., based on the input data. In detail, the density map may be extracted from the layout and may therefore differ from an actually exposed pattern.

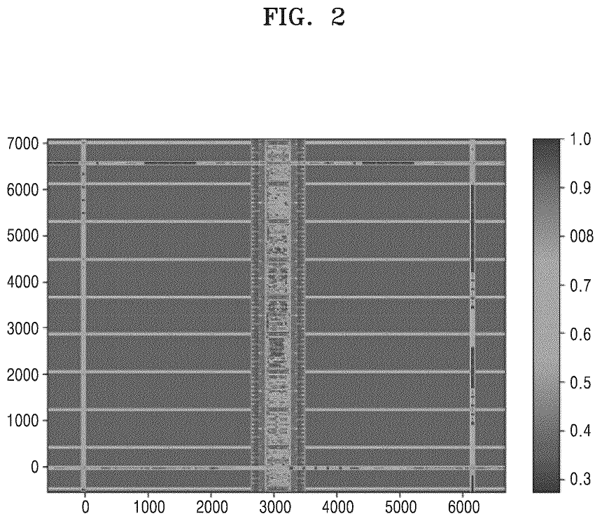

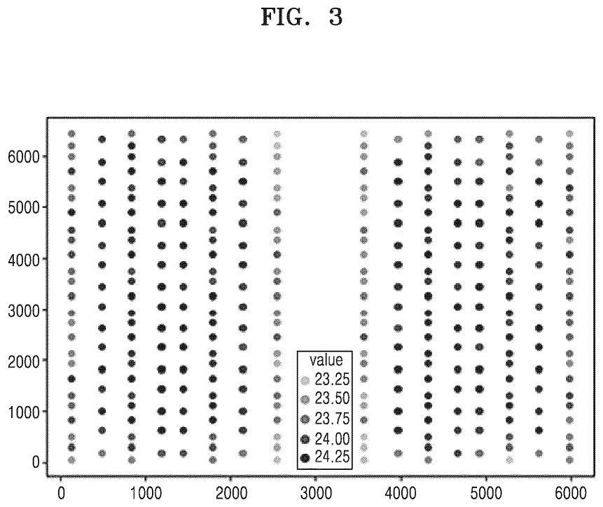

For example, FIG. 2 is an image showing a density map for a full-chip. FIG. 3 is an image showing an after-development-inspection critical dimension (ADI CD) measuring results. In particular, FIG. 3 is an image showing an ADI CD map.

The density map may refer to a map indicating the density of patterns. For example, a portion where the patterns are densely formed may have high density, and a portion where the patterns are sparsely formed may have low density.

Referring to FIGS. 2 and 3, it may be observed that the density map of FIG. 2 is different from the ADI CD measurement results of FIG. 3. In particular, when the density map of FIG. 2 fits with the ADI CD measurement results of FIG. 3, it may be confirmed that a correlation between the two results is low. For example, the density of the right edge area of the density map of FIG. 2 is shown to be higher than the density of the right edge area of the ADI CD map of FIG. 3. Accordingly, a process of correcting the density map of FIG. 2 to increase the correlation with the ADI CD map of FIG. 3 is required.

In particular, in a process of transferring a full-shot layout including a bit line pad (BLP) layer of dynamic random-access memory (DRAM), when a metal organic resist (MOR) is used, a phenomenon in which the CD decreases along the interface of the full-chip occurs, and this may be due to the pattern density. For example, a phenomenon in which CD decreases at the interface having high pattern density may occur. A process of performing OPC by correcting the phenomenon is required.

Next, referring to FIG. 1, a blurred density map may be extracted (S130). As described above, operation S130 of extracting the blurred density map may be performed so that the correlation between the density map of FIG. 2 and the ADI CD map of FIG. 3 increases.

To extract the blurred density map, a kernel function may be convolutioned with the density map extracted in operation S120 of extracting the density map. The kernel may be, for example, a Gaussian kernel. In particular, the density map may be blurred by convolutioning a Gaussian kernel with the density map.

For example, operation S130 of extracting the blurred density map may be performed through the following process. First, a first blurred density map may be extracted by convolutioning a first Gaussian kernel with the density map. Thereafter, a correlation between the first blurred density map and the ADI CD map of FIG. 3 may be derived. When the correlation between the first blurred density map and the ADI CD map is lower than a preset value, a second blurred density map may be extracted by convolutioning a second Gaussian kernel with the density map. Similarly, a correlation between the second blurred density map and the ADI CD map may be derived and compared with the preset value. The above process may be repeated so that the correlation between a blurred density map and the ADI CD map is the preset value or more, thereby extracting the blurred density map. For example, a blurred density map having a correlation with the ADI CD map of 0.8 or more may be extracted.

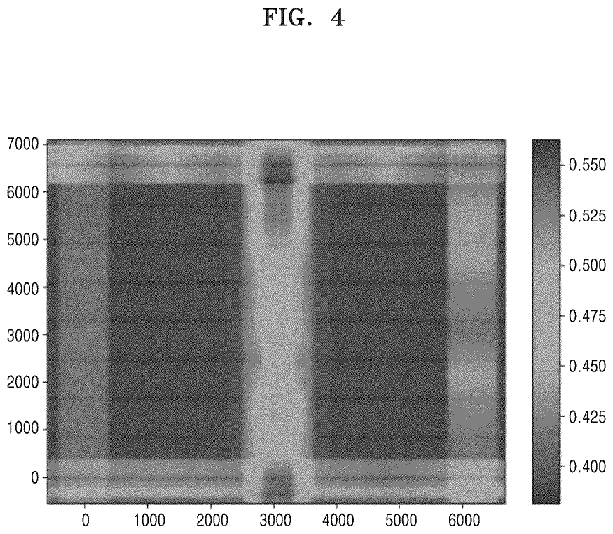

For example, FIG. 4 is an image showing a blurred density map for a full-chip. Referring to FIG. 4, it may be confirmed that a correlation between the blurred density map of FIG. 4 and the ADI CD measurement results of FIG. 3 is higher than the correlation between the density map of FIG. 2 and the ADI CD measurement results of FIG. 3. For example, it may be confirmed that the density of the right edge area of the blurred density map of FIG. 4 becomes similar to the density of the right edge area of the ADI CD map of FIG. 3.

According to the inventive concepts described above with reference to FIGS. 1, 3, and 4, the full-shot layout correction method S100 including operation S130 of extracting the blurred density map may be provided. In other words, the reliability of the full-shot layout correction method S100 may be improved by including operation S130 of extracting a blurred density map having a high correlation with the ADI CD measurement results.

Then, referring to FIG. 1, a correction area may be defined (S140). In particular, operation S130 of defining the correction area may be performed based on a blurred density map of a full-shot scale.

In some embodiments, the correction area may be defined based on density. In particular, when the density of patterns in a certain area is greater than a preset value, the certain area may be defined as a correction area. The patterns may include cell patterns and core patterns. For example, when the density of the cell patterns and/or the core patterns within a certain area is greater than a preset reference density value, the area may be defined as a correction area. For example, the density of patterns within the correction area may be greater than the density of patterns within an area other than the correction area.

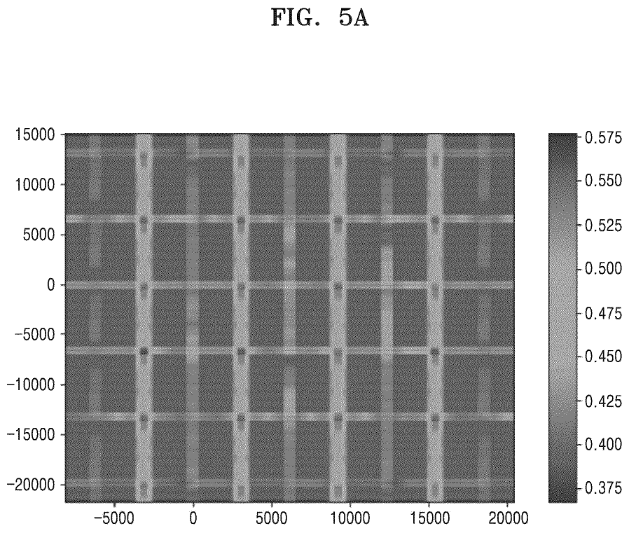

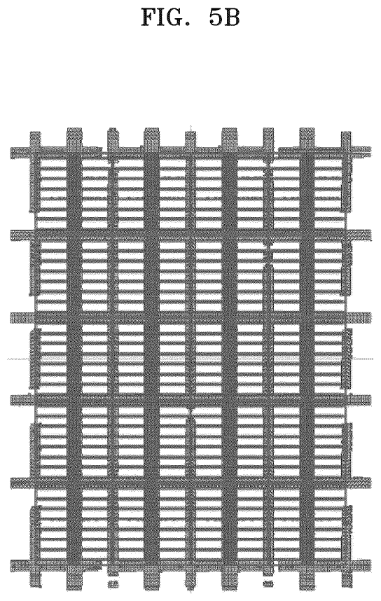

For example, FIGS. 5A and 5B are images showing a full-shot blurred density map and a correction area, respectively. In particular, the defining of the correction area based on the full-shot blurred density map of FIG. 5A is shown in FIG. 5B. For example, FIG. 5B shows that an area having the density of patterns, that is greater than 0.4, is defined as a correction area based on the full-shot blurred density map of FIG. 5A.

Then, referring to FIG. 1, separating cell patterns and core patterns, which overlap the correction area, may be performed (S150).

As described above, the correction area is defined for an area having a higher density of cell patterns and/or core patterns than the preset reference density value, and may be defined for both cell patterns and core patterns. Accordingly, to perform an OPC on each of the cell patterns and the core patterns, an operation of separating the cell patterns and the core patterns may be performed. In other words, the cell patterns in the correction area and the core patterns in the correction area may be separated.

Next, referring to FIGS. 1 to 6 together, an OPC on the cell patterns may be performed (S160).

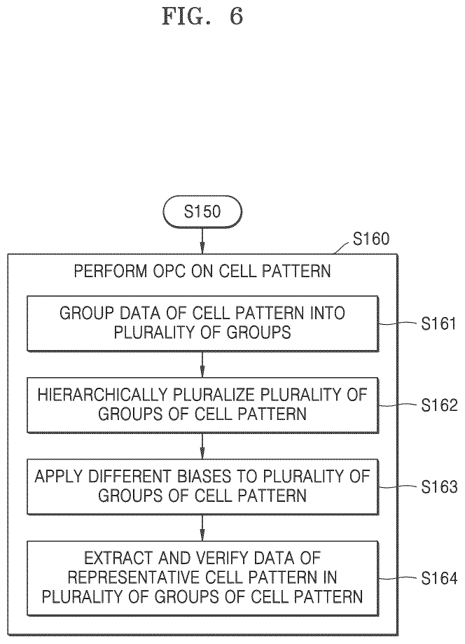

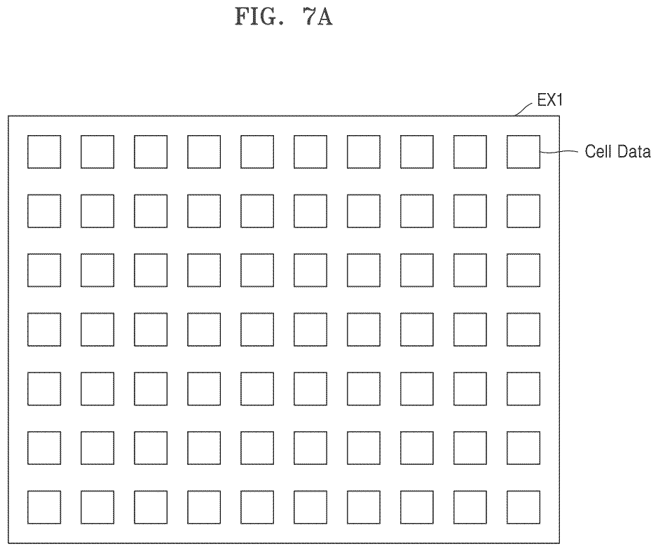

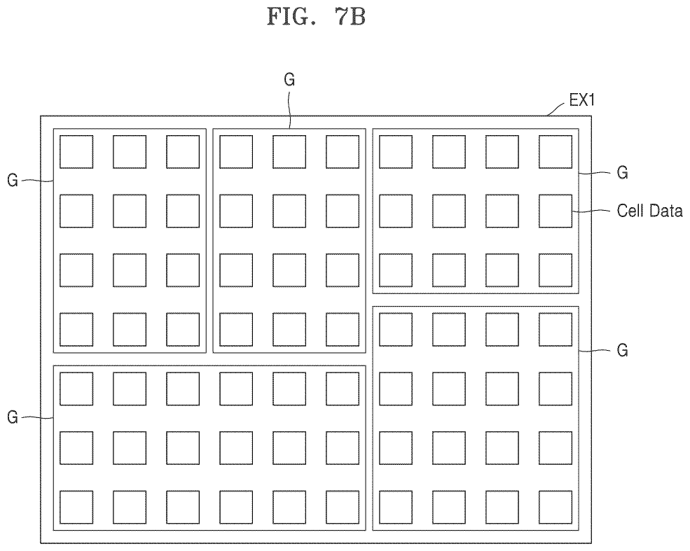

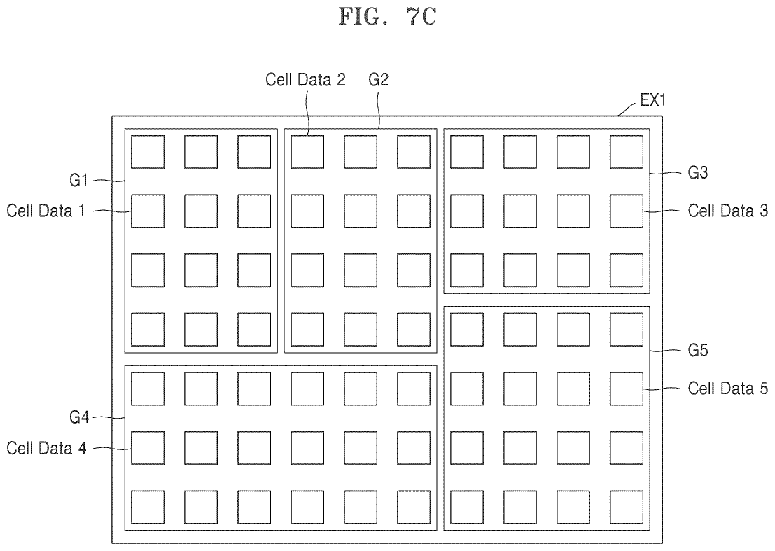

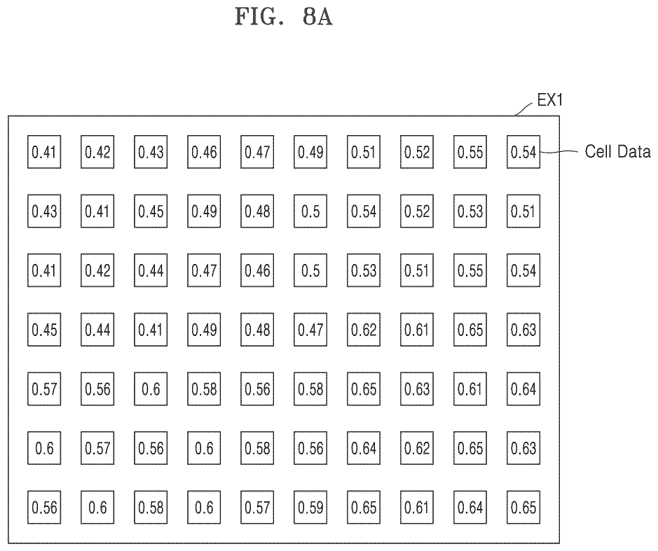

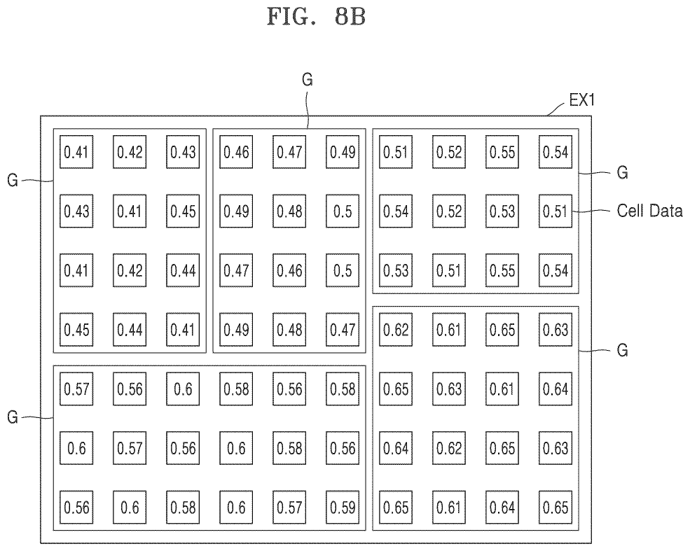

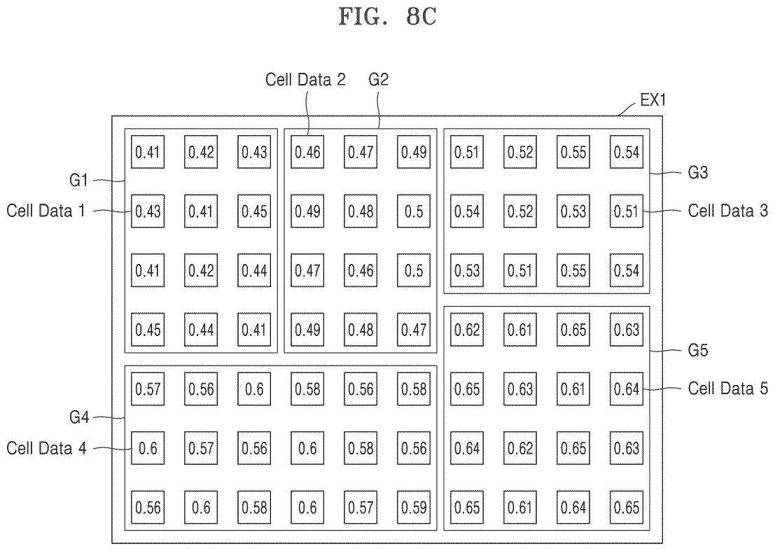

FIG. 6 is a flowchart illustrating the process of operation S160 of performing an OPC on cell patterns in the full-shot layout correction method S100 according to some embodiments. FIGS. 7A to 7C are diagrams schematically showing cell data of cell patterns to describe operation S160 of performing the OPC on the cell patterns, which schematically shows cell data of cell patterns in a virtual EX1 area to describe operation S160 of performing an OPC on cell patterns. FIGS. 8A to 8C are diagrams schematically illustrating cell data of cell patterns to describe operation S160 of performing the OPC on the cell patterns. Operation S160 of performing the OPC on the cell patterns is described below with reference to FIGS. 7A to 7C and 8A to 8C together.

As illustrated in FIG. 6, cell data of cell patterns are grouped into a plurality of groups (S161).

Referring to FIG. 7A together, the EX1 area may include cell data of cell patterns. The EX1 area of FIG. 7A may be a portion of the correction area defined in operation S140 of defining the correction area described above. In particular, the EX1 area may be a portion of an area including cell patterns separated in operation S150 of separating the cell patterns and the core patterns, which overlap the correction area. Each piece of cell data of cell patterns shown in FIG. 7A may be a 9-cell unit. The 9-cell unit may include a set of nine areas outside the optical influence range within one cell block. The nine areas in the 9-cell unit may generally represent the top-left, top, top-right, left, center, right, bottom-left, bottom, and bottom-right portions in a cell block, respectively.

Then, referring to FIG. 7B, the cell data of the cell patterns in the EX1 area may be grouped into a plurality of groups G. In some embodiments, each of the plurality of groups G may include cell data of a plurality of cell patterns positioned adjacent to each other, which is grouped into one group. In FIG. 7B, the hierarchies of the plurality of groups G are not differentiated from each other and may be unified.

As illustrated in FIG. 6, the plurality of groups of cell patterns may be hierarchically pluralizing (S162).

Referring to FIG. 7C, the plurality of groups G (refer to FIG. 7B) may be hierarchically pluralized.

In particular, the plurality of groups G, which are generally not differentiated from each other and which may have a unified hierarchy, may be given hierarchies to become a plurality of groups G1 to G5, which are differentiated from each other and have a pluralistic hierarchy. For example, after the plurality of groups G are extracted, the hierarchical names thereof may be changed to be hierarchically pluralized as a first group G1, a second group G2, a third group G3, a fourth group G4, and a fifth group G5. In some embodiments, cell data (refer to FIG. 7B) of cell patterns may also be hierarchically pluralized together through the pluralizing of the plurality of groups. In particular, the data of the cell patterns of the first group G1, the data of the cell patterns in the second group G2, the data of the cell patterns in the third group G3, the data of the cell patterns of the fourth group G4, and the data of the cell patterns in the fifth group G5 may be hierarchically pluralized as cell data 1, cell data 2, cell data 3, cell data 4, and cell data 5, respectively. As illustrated in FIG. 6, different biases may be applied to the plurality of groups of cell patterns (S163).

In particular, an OPC may be performed on cell patterns by adding a bias to cell data 1 to cell data 5 of the cell patterns of the plurality of groups G1 to G5. Here, the applying of the bias may mean increasing or decreasing the CD of a layout of the patterns by the bias. At this time, different biases may be added to the plurality of groups G1 to G5. At this time, the same bias may be applied to the data of the cell patterns of each of the plurality of groups G1 to G5. For example, a first bias may be applied to the cell data 1 of the first group G1. A second bias may be applied to the cell data 2 of the second group G2. A third bias may be applied to the cell data 3 of the third group G3. A fourth bias may be applied to the cell data 4 of the fourth group G4. A fifth bias may be applied to the cell data 5 of the fifth group G5. As illustrated in FIG. 6, operation S164 of extracting and verifying cell data of a representative cell pattern of the plurality of groups of cell patterns may be further performed.

This may be performed to verify that the OPC of the cell pattern has been properly performed after operation S163 of applying different biases to the plurality of groups of cell patterns is performed. At this time, data of the representative cell pattern may be extracted from each of the plurality of groups G1 to G5 and verified. According to the inventive concepts described above with reference to FIGS. 1, 6, and 7A to 7C, operation S160 of performing an OPC on a cell pattern is provided, wherein operation S160 includes operation S161 of grouping cell data of cell patterns into a plurality of groups, operation S162 of hierarchically pluralizing the plurality of groups of cell patterns, operation S163 of applying different biases to the plurality of groups of cell patterns, and operation S164 of extracting and verifying data of a representative cell pattern of the plurality of groups of cell patterns.

In particular, when an OPC is performed by applying a bias to data of each cell pattern without grouping the data of cell patterns, the risk of errors occurring may increase due to the large amount of data. Conversely, as described in the inventive concepts, when cell data of cell patterns are grouped, the cell data of cell patterns are hierarchically pluralized and divided, and a bias is applied to each group, time and cost may be saved, and the amount of data to be processed may also be reduced to reduce the risk of occurring errors. That is, according to some embodiments, the full-shot layout correction method S100 that saves time and cost may be provided.

That is, according to some embodiments, the full-shot layout correction method S100 with improved performance and reliability may be provided. In some embodiments, operation S160 of performing an OPC on cell patterns described with reference to FIGS. 1, 6, and 7A to 7C may be performed based on the density of cell patterns.

Hereinafter, a description is made with reference to FIGS. 8A to 8C. Referring to FIG. 8A, the cell data of cell patterns in the EX1 area may include data about the density of each cell pattern.

For example, as described above, operation S140 of defining a correction area may be defined as an area having a density of patterns of more than 0.4, and accordingly, the cell data of the cell patterns in the EX1 area may each include data having a density of more than 0.4. Referring to FIG. 8B, similarly to the description made with reference to FIGS. 6 and 7B, operation S161 of grouping the data of cell patterns into a plurality of groups may be performed.

At this time, the plurality of groups G may be generated based on the density of the cell patterns. In particular, the plurality of groups G may be grouped so that the density of the cell patterns of each of the plurality of groups G may be positioned within the same density section. For example, the plurality of groups G may be grouped to include data having a density positioned within the same section among a first section having a density of cell patterns of more than 0.4 and 0.45 or less, a second section having a density of cell patterns of more than 0.45 and 0.5 or less, a third section having a density of cell patterns of more than 0.5 and 0.55 or less, a fourth section of more than 0.55 and 0.6 or less, and a fifth section of more than 0.6 and 0.65 or less.

Referring to FIG. 8C, similarly to the description made with reference to FIGS. 6 and 7C, operation S162 of hierarchically pluralizing the plurality of groups of cell patterns may be performed.

For example, the plurality of groups G may be hierarchically pluralized as a first group G1 having cell data 1 of a density positioned within the first section of more than 0.4 and 0.45 or less, a second group G2 including cell data 2 of a density positioned within the second section of more than 0.45 and 0.5 or less, a third group G3 having cell data 3 of a density positioned within the third section of more than 0.5 and 0.55 or less, a fourth group G4 having cell data 4 of a density positioned within the fourth section of more than 0.55 and 0.6 or less, and a fifth group G5 having cell data 5 of a density positioned within the fifth section of more than 0.6 and 0.65 or less. Thereafter, similarly to the description made with reference to FIG. 6, operation S163 of applying difference biases to the plurality of groups of cell patterns may be performed.

For example, a first bias may be applied to the cell data 1 of the first group G1 of the first section of more than 0.4 and 0.45 or less to reduce the density by 0.05.

For example, a second bias may be applied to the cell data 2 of the second group G2 of the second section of more than 0.45 and 0.5 or less to reduce the density by 0.1. For example, a third bias may be applied to the cell data 3 of the third group G3 of the third section of more than 0.5 and 0.55 or less to reduce the density by 0.15. For example, a fourth bias may be applied to the cell data 4 of the fourth group G4 of the fourth section of more than 0.55 and 0.6 or less to reduce the density by 0.2. For example, a fifth bias may be applied to the cell data 5 of the fifth group G5 of the fifth section of more than 0.6 and 0.65 or less to reduce the density by 0.25. CD errors may be statistically calculated according to the densities, and the first to fifth biases may be set to amounts that may compensate for the CD errors. In some other embodiments, unlike the above description made with reference to FIGS. 7A to 7C and 8A to 8C, a plurality of groups defined as the same group may be included within one area.

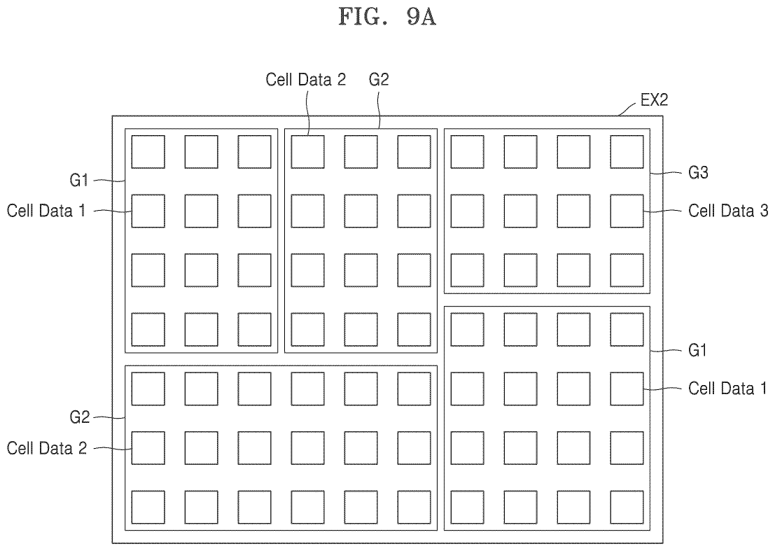

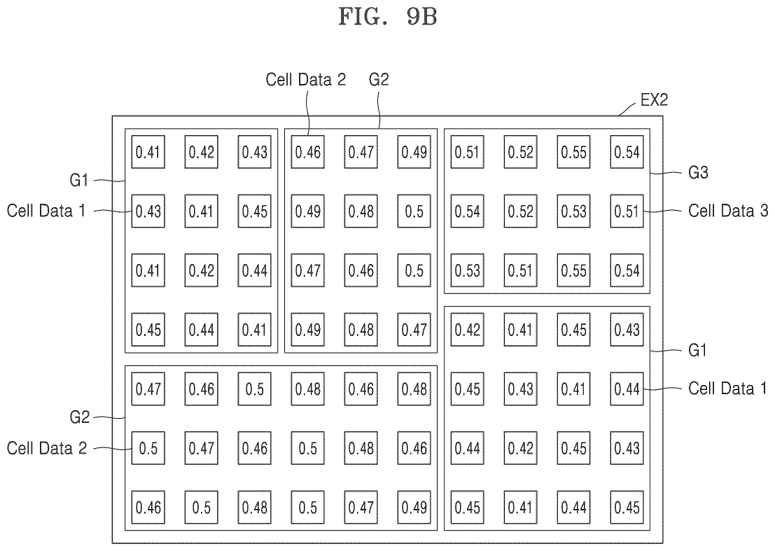

FIGS. 9A and 9B are diagrams schematically showing data of cell patterns, which schematically show data of cell patterns in a virtual EX2 area to describe the process of performing an OPC on cell patterns. Hereinafter, other embodiments are described with reference to FIGS. 9A to 9B. Referring to FIG. 9A, the EX2 area may include data of cell patterns.

The EX2 area may be a portion of the correction area defined in operation S140 of defining the correction area described above. In particular, the EX2 area may be a portion of an area including cell patterns separated in operation S150 of separating the cell patterns and the core patterns, which overlap the correction area. Each piece of cell data of cell patterns shown in FIG. 9A may be a 9-cell unit. As illustrated in FIG. 9A, after grouping the cell data of cell patterns in the EX2 area into a plurality of groups, the plurality of groups may be hierarchically pluralized.

For example, the data of cell patterns in the EX2 area may be grouped into a first group G1, a second group G2, and a third group G3. At this time, in the EX2 area, two groups may be grouped into the first group G1, and two groups may be grouped into the second group G2. The two groups named the first group G1 may have similar characteristics. The hierarchies of the two first groups G1 may be the same. The two groups named as the second group G2 may have similar characteristics. The hierarchies of the two second groups G2 may be the same. Similarly, through the hierarchically pluralizing of the plurality of groups, the data of cell patterns of the first group G1 may be hierarchically pluralized as cell data 1, the data of cell patterns of the second group G2 may be hierarchically pluralized as cell data 2, and the data of cell patterns of the third group G3 may be hierarchically pluralized as cell data 3.

At this time, the hierarchies of the cell data 1 of the two first groups G1 may be the same. The hierarchies of the cell data 2 of the two second groups G2 may be the same. Subsequently, an OPC may be performed on the cell patterns by applying different biases to the plurality of groups of the EX2 area.

For example, a first bias may be applied to the cell data 1 of the two first groups G1. A second bias may be applied to the cell data 2 of the two second groups G2. A third bias may be applied to the cell data 3 of the third group G3. Referring to FIG. 9B, the cell data of cell patterns of the EX2 area may include data about the density of each cell pattern.

For example, as described above, operation S140 of defining a correction area may be defined as an area having a density of patterns of more than 0.4, and accordingly, the cell data of the cell patterns in the EX2 area may each include data having a density of more than 0.4. As illustrated in FIG. 9B, after grouping the cell data of cell patterns in the EX2 area into a plurality of groups, the plurality of groups may be hierarchically pluralized.

The plurality of groups may be grouped so that the density of cell patterns in each of the plurality of groups is positioned within the same density section. For example, the data of cell patterns in the EX2 area may be grouped into a first group G1, a second group G2, and a third group G3.

For example, the plurality of groups G may be hierarchically pluralized as a first group G1 including cell data 1 of a density positioned within a first section of more than 0.4 and 0.45 or less, a second group G2 including cell data 2 of a density positioned within a second section of more than 0.45 and 0.5 or less, and a third group G3 including cell data 3 of a density positioned within a third section of more than 0.5 and 0.55 or less. At this time, two groups named the first group G1 may each include data having the density positioned within the same section.

The hierarchies of the cell data 1 of the two first groups G1 may be the same. Two groups named the second group G2 may each include data having the density within the same section. The hierarchies of the cell data 2 of the two second groups G2 may be the same. Subsequently, an OPC may be performed on the cell patterns by applying different biases to the plurality of groups of the EX2 area.

For example, a first bias may be applied to the cell data 1 of the first group G1 of the first section of more than 0.4 and 0.45 or less to reduce the density by 0.05. At this time, the first bias may be applied to the cell data 1 of each of the two first groups G1. For example, a second bias may be applied to the cell data 2 of the second group G2 of the second section of more than 0.45 and 0.5 or less to reduce the density by 0.1. At this time, the second bias may be applied to the cell data 2 of each of the two second groups G2. For example, a third bias may be applied to the cell data 3 of the third group G3 of the third section of more than 0.5 and 0.55 or less to reduce the density by 0.15. According to the inventive concepts described above with reference to FIGS. 9A to 9B, operation S160 of performing an OPC on cell patterns may include grouping cell data of cell patterns with similar characteristics into one group and giving the same hierarchy to groups including the cell data of cell patterns with similar characteristics.

In addition, the same bias may be applied to groups including cell data of cell patterns with similar characteristics. Accordingly, time and cost may be saved, and the risk of errors occurring may also be reduced. That is, according to at least one embodiment, the full-shot layout correction method S100 that saves time and cost may be provided.

That is, the full-shot layout correction method S100 with improved reliability may be provided. Referring to FIG. 1 again, a full-shot layout may be reconstructed (S170).

In particular, after performing the OPC on the cell patterns (S160), a process of reconstructing the cell patterns on which the OPC has been performed into a shot layout may be performed (S170). As described above, a full-shot layout may include cell patterns and core patterns, and the cell patterns and the core patterns may be designed to be organic to each other.

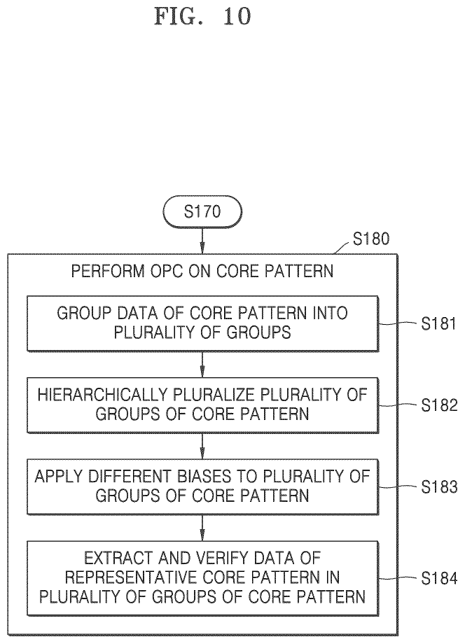

At this time, when the OPC is performed on the cell patterns, the core patterns that recognize the cell patterns as a surrounding environment also require an OPC according to the cell patterns. Accordingly, a full-shot layout may be reconstructed with the cell patterns on which the OPC has been performed. Next, referring to FIGS. 1 and 10, an OPC on core patterns may be performed (S180).

FIG. 10 is a flowchart illustrating the process of operation S180 of performing an OPC on core patterns in the full-shot layout correction method S100 according to some embodiments.

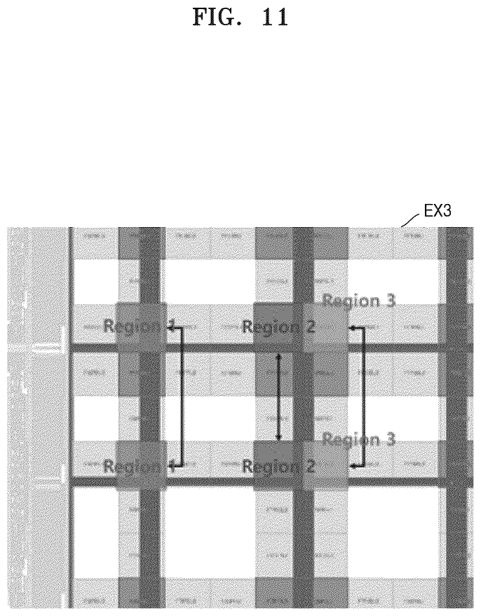

FIG. 11 is an image schematically showing grouping of core data of core patterns of an EX3 area to describe the process of performing an OPC on the core patterns. As illustrated in FIG. 10, grouping core data of core patterns into a plurality of groups (S181) may be performed.

Similar to the description made above with reference to FIGS. 6, 7A, and 7B, the core data of core patterns may be grouped into a plurality of groups. As illustrated in FIG. 10, the plurality of groups of core patterns may be hierarchically pluralizing (S182).

Similar to the description made above with reference to FIGS. 6 and 7C, a process of hierarchically pluralizing the plurality of groups of core patterns may be performed. For example, referring to FIG. 11, the core data of core patterns may be grouped into a plurality of groups, and the plurality of groups may be hierarchically pluralized.

The EX3 area of FIG. 11 may be a portion of the correction area defined in operation S140 of defining the correction area described above. The EX3 area may include both cell patterns and core patterns. As illustrated in FIG. 11, the core data of core patterns may include a region 1, a region 2, and a region 3.

For example, the core data of core patterns may include two regions 1, a region 2, and a region 3. The core data of core patterns within the region 1 may have similar characteristics to each other, and the core data of core patterns within two areas named the region 1 may have similar characteristics to each other.

Similarly, the core data of core patterns within the region 2 may have similar characteristics to each other, and the core data of core patterns within two areas named the region 2 may have similar characteristics to each other. The core data of core patterns within the region 3 may have similar characteristics to each other, and the core data of core patterns within two areas named the region 3 may have similar characteristics to each other. For example, when the surrounding cell patterns are similar, the cell patterns may be grouped into one area.

Alternatively, when the densities of core patterns within areas are located within the same section, the core patterns may be grouped into one area. As illustrated in FIG. 10, different biases may be applied to the plurality of groups of cell patterns (S180).

For example, a first OPC may be performed on the region 1 of FIG. 11. A second OPC may be performed on the region 2. A third OPC may be performed on the region 3. The first OPC, the second OPC, and the third OPC may include applying different biases, respectively (S183). As illustrated in FIG. 10, extracting and verifying core data of a representative core pattern of the plurality of groups of core patterns (S184) may be further performed.

In particular, core data of a representative core pattern may be extracted from each of the region 1, the region 2, and the region 3. According to the inventive concepts described with reference to FIGS. 1, 10, and 11, an OPC may be performed on core patterns (S180), wherein operation S180 includes operation S181 of grouping core data of core patterns into a plurality of groups, operation S182 of hierarchically pluralizing the plurality of groups of core patterns, operation S183 of applying different biases to the plurality of groups of core patterns, and operation S184 of extracting and verifying core data of a representative core pattern in the plurality of groups of cell patterns.

Similar to the grouping and hierarchically pluralizing of cell data of cell patterns, core data of core patterns may be grouped and hierarchically pluralized to save time and cost, and the risk of occurring errors may also be reduced. That is, according to an embodiment, the full-shot layout correction method S100 that saves time and cost may be provided.

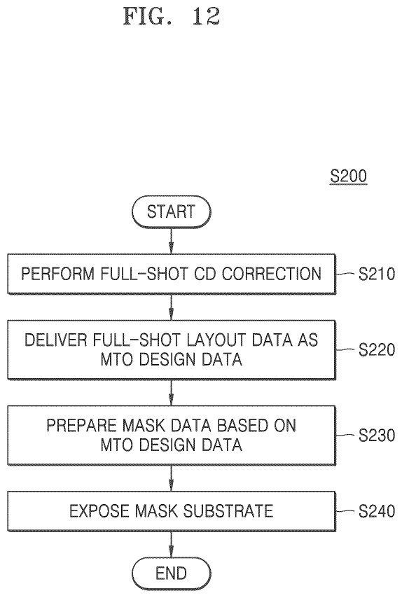

That is, the full-shot layout correction method S100 with improved reliability may be provided. FIG. 12 is a flowchart schematically illustrating the processes of a mask manufacturing method S200 including a full-shot layout correction method according to some embodiments.

Referring to FIG. 12, performing a full-shot CD correction may be performed (S210).

Operation S210 of performing the full-shot CD correction of the mask manufacturing method S200 may include the full-shot layout correction method S100 described with reference to FIGS. 1 to 11. In particular, operation S210 of performing the full-shot CD correction may be performed by including operation S110 of inputting data of a full-shot layout, operation S120 of extracting a density map, operation S130 of extracting a blurred density map, operation S140 of defining a correction area, operation S150 of separating cell patterns and core patterns, which overlap the correction area, operation S160 of performing an OPC on the cell patterns, operation S170 of reconstructing a full-shot layout, and operation S180 of performing an OPC on the core patterns.

Thereafter, referring to FIG. 12, delivering the data of the full-shot layout as mask tape-out (MTO) design data (S220), preparing mask data based on the MTO design data (S230), and exposing a mask substrate based on the mask data (240) may be performed.

Operation S220 of delivering the data of the full shot layout as the MTO design data, operation mask manufacturing method may be performed through the following processes.

First, layout data, on which the OPC has been performed, for a full-shot is delivered to a mask manufacturing team as MTO design data.

Generally, MTO may mean handing over the final mask data obtained through the OPC method to the mask manufacturing team to request mask manufacturing. Accordingly, the MTO design data may ultimately be substantially the same as data, on which the OPC has been performed, for a full-shot layout, wherein the data is obtained through a full-shot layout correction method. The MTO design data may have a graphic data format used in Electronic Design Automation (EDA) software or the like. For example, the MTO design data may have a data format, such as Graphic Data System II (GDS2), Open Artwork System Interchange Standard (OASIS), or the like. Thereafter, mask data preparation (MDP) is performed.

The MDP may include, for example, i) format conversion, which is called fracturing, ii) augmentation of barcodes for mechanical reading, standard mask patterns for inspection, job-decks, or the like, and iii) verification in automatic and manual methods. Here, a job-deck may mean creating a test file regarding a series of instructions such as arrangement information of multiple mask files, standard dose, and exposure speed or methods. The format conversion, that is, fracturing, may mean a process of dividing the MTO design data into each area and changing the MTO design data to a format for an electron beam exposure machine.

The fracturing may include data manipulation, such as scaling, sizing of data, rotation of data, pattern reflection, color inversion, or the like. In a conversion process through fracturing, data may be corrected for numerous systematic errors that may occur somewhere during the delivery from design data to an image on a wafer. The data correction process for the systematic error may be referred to as mask process correction (MPC), and may include, for example, line width scaling called CD scaling, operations for increasing the pattern arrangement precision, or the like. Accordingly, the fracturing may contribute to improving the quality of a final mask and may also be a process that is performed in advance for MPC. Here, the systematic errors may be caused by distortions occurring in an exposure process, a mask development and etching process, a wafer imaging process, or the like. The MDP may include MPC.

As described above, the MPC refers to a process of correcting errors that occur during an exposure process, that is, systematic errors. Here, the exposure process may be an overall concept that includes electron beam writing, development, etching, baking, or the like. In addition, data processing may be performed before an exposure process. The data processing is a kind of preprocessing process for mask data, and may include grammar checks for mask data, exposure time prediction, and/or the like. Through the MDP, E-beam data to expose a mask substrate may be generated. After the MDP, the mask substrate is exposed by using the mask data and the E-beam data.

Here, exposure may mean, for example, E-beam writing. Here, E-beam writing may be performed, for example, through a gray writing method using a multi-beam mask writer (MBMW). In addition, the E-beam writing may also be performed by using a variable shape beam (VSB). After the process of MDP and before the exposure process, a process of converting the E-beam data into pixel data may be performed.

The pixel data is data directly used in actual exposure and may include data about the shape of an object to be exposed and data about the dose of the E-beam assigned to each object. Here, the data about the shape may be bit-map data obtained by converting the shape data, which is vector data, through rasterization or the like. After the exposure process, a series of processes may be performed to complete the mask.

The series of processes may include, for example, development, etching, cleaning, or the like. In addition, the series of processes for mask manufacturing may include a metrology process, defect inspection, or a defect repair process. In addition, a pellicle application process may also be included. Here, the pellicle application process may refer to a process of attaching a pellicle to a mask surface to protect the mask from subsequent contamination during mask delivery and the lifespan of the mask after it is confirmed that there are no contaminants or chemical stains after final cleaning and inspection. In other words, operation S220 of manufacturing a mask by using the full-shot layout correction method S100 described with reference to FIGS. 1 to 11 may be performed.

In at least one embodiment, the steps of FIGS. 1 and/or 12 may be implemented by processing circuitry such as hardware, software, or a combination thereof configured to perform a specific function. For example, the processing circuitry more specifically may include (and/or be included in), but is not limited to, a central processing unit (CPU), a neural processing unit (NPU), deep learning processor (DLP), an arithmetic logic unit (ALU), a digital signal processor, a microcomputer, a field programmable gate array (FPGA), and programmable logic unit, a microprocessor, application-specific integrated circuit (ASIC), etc.

In at least one embodiment, the steps of FIGS. 1 and 12 may be implemented by processing circuitry included in and/or configured to control a semiconductor processing apparatus such that, the mask manufacturing, and/or the series of processes (e.g., including, development, etching, cleaning, or the like) are controlled based on the results of steps of FIG. 1. As such, a chip may be produced using a mask manufactured based on results of the OPC model.

That is, a mask manufacturing method with improved performance and reliability may be provided. A mask manufacturing method that saves time and cost may be provided. The mask manufacturing method S200 described with reference to FIG. 12 may include the full-shot layout correction method S100 described with reference to FIGS. 1 to 11 to manufacture a mask with improved performance and reliability, thereby improving the performance and reliability.

While the inventive concepts have been particularly shown and described with reference to some embodiments thereof, it will be understood that various changes in form and details may be made therein without departing from the spirit and scope of the following claims.

What is claimed is:

1. A full-shot layout correction method comprising:
extracting a density map from a full-shot layout;
extracting a blurred density map by blurring the density map;
defining a correction area based on the blurred density map;
separating a cell pattern and a core pattern, which overlap the correction area, from the blurred density map;
performing an optical proximity correction (OPC) on the cell pattern; and
reconstructing the full-shot layout using the cell pattern on which the OPC has been performed.

2. The full-shot layout correction method of claim 1, wherein the performing the OPC on the cell pattern comprises grouping data of the cell pattern into a plurality of groups.

3. The full-shot layout correction method of claim 2, wherein the performing the OPC on the cell pattern further comprises hierarchically pluralizing the plurality of groups after the grouping of the data of the cell pattern.

4. The full-shot layout correction method of claim 3, wherein the performing the OPC on the cell pattern further comprises further comprises applying different biases to the plurality of groups after the hierarchically pluralizing the plurality of groups.

5. The full-shot layout correction method of claim 2, wherein the grouping the data of the cell pattern comprises grouping the data so that a density of the cell pattern of each of the plurality of groups is positioned within a same density section, of a plurality of density sections, and each of the plurality of density sections includes a range of densities.

6. The full-shot layout correction method of claim 2, further comprising:
extracting and verifying data of a representative cell pattern of each of the plurality of groups after the performing the OPC on the cell pattern.

7. The full-shot layout correction method of claim 1, wherein the extracting the blurred density map comprises generating the blurred density map by convolutioning to the density map with a Gaussian kernel.

8. The full-shot layout correction method of claim 1, wherein the defining the correction area comprises defining an area having at least one of a density of the cell pattern or a density of the core pattern greater than a preset value as the correction area.

9. The full-shot layout correction method of claim 1, wherein the reconstructing the full-shot layout includes performing an OPC on the core pattern in.

10. A full-shot layout correction method comprising:
extracting a density map from a full-shot layout;
extracting a blurred density map by blurring the density map;
defining a correction area based on the blurred density map;
separating a cell pattern and a core pattern, which overlap the correction area, from the blurred density map;
performing an optical proximity correction (OPC) on the cell pattern; and
performing an OPC on the core pattern based on the cell pattern on which the OPC has been performed.

11. The full-shot layout correction method of claim 10, wherein the performing the OPC on the core pattern comprises grouping data of the core pattern into a plurality of groups.

12. The full-shot layout correction method of claim 11, wherein the performing the OPC on the core pattern further comprises hierarchically pluralizing the plurality of groups after the grouping of the data of the core pattern.

13. The full-shot layout correction method of claim 11, wherein the grouping the data of the core pattern comprises grouping the data so that a density of the core pattern of each of the plurality of groups is positioned within a same density section, of a plurality of density sections, and each of the plurality of density sections includes a range of densities.

14. The full-shot layout correction method of claim 13, wherein the performing the OPC on the core pattern further comprises applying different biases to the plurality of groups.

15. The full-shot layout correction method of claim 14, further comprising:
applying a same bias to groups of which densities of the core pattern are positioned within the same density section.

16. The full-shot layout correction method of claim 10, wherein the performing the OPC on the cell pattern comprises grouping data of the cell pattern into a plurality of groups.

17. A mask manufacturing method comprising:
extracting a density map from a full-shot layout, the full-shot layout comprising a cell pattern and a core pattern;
extracting a blurred density map by blurring the density map;
defining, based on the blurred density map, an area in the full-shot layout as a correction area, the correction area having at least one of a density of the cell pattern or a density of the core pattern greater than a preset value;
separating the cell pattern and the core pattern, which overlap the correction area, from the blurred density map;
grouping data of the cell pattern into a plurality of cell pattern groups;
hierarchically pluralizing the plurality of cell pattern groups;
performing an optical proximity correction (OPC) on the cell pattern of the plurality of cell pattern groups on which the hierarchically pluralizing has been performed;
reconstructing the full-shot layout using the cell pattern on which the OPC has been performed;
grouping the data of the core pattern into a plurality of core pattern groups;
hierarchically pluralizing the plurality of core pattern groups;
performing an OPC on the core pattern of the plurality of core pattern groups on which the hierarchically pluralizing has been performed, based on the cell pattern on which the OPC has been performed;
delivering full-shot layout data, on which the OPC has been performed, as mask tape-out (MTO) design data;
preparing mask data based on the MTO design data; and
preparing a mask by exposing a mask substrate based on the mask data.

18. The mask manufacturing method of claim 17, wherein the grouping the data of the cell pattern comprises grouping the data so that a density of the cell pattern of each of the plurality of cell pattern groups is positioned within a same density section and each of the density sections includes a range of densities.

19. The mask manufacturing method of claim 17, wherein the grouping the data of the core pattern comprises grouping the data so that a density of the core pattern of each of the plurality of core pattern groups is positioned within a same density section, of a plurality of density sections, and each of the plurality of density sections includes a range of densities.

20. The mask manufacturing method of claim 17, wherein the performing the OPC on the cell pattern comprises applying different biases to the plurality of cell pattern groups, and
wherein the performing of the OPC on the core pattern comprises applying different biases on the plurality of core pattern groups.
